(19) United States
(12) Patent Application Publication
(10) Pub. No.: US 2014/0263918 A1
(43) Pub. Date: Sep. 18, 2014

(54) NOVEL DISPLAY STANDS

(71) Applicant: Koh Hong LYE, San Francisco, CA (US)

(72) Inventor: Koh Hong LYE, San Francisco, CA (US)

(21) Appl. No.: 13/918,872

(22) Filed: Jun. 14, 2013

Related U.S. Application Data
(60) Provisional application No. 61/801,534, filed on Mar. 15, 2013.

(51) Int. Cl. F16M 11/00

(52) U.S. Cl. CPC F16M 11/00
USPC 248/371; 248/127

(57) ABSTRACT

A novel display stand is described. The display stand includes: (i) a housing; and (ii) a supporting frame retractable from the housing; and wherein when the supporting frame is retracted from the housing, and in an operational state of the display stand, the supporting frame contacts the housing and is immobilized with respect to the housing.

### RELATED APPLICATION

The present application claims priority from U.S. Provisional Application having Ser. No. 61/801,534, filed on Mar. 15, 2013, which is incorporated herein by reference for all purposes.

### FIELD OF THE INVENTION

The present invention relates generally to display stands. More particularly, the present invention relates to portable and adjustable display stands for PC tablets, e-readers, smartphones, video displays, artwork, photographs, or the like.

### BACKGROUND

The recent and expanding popularity of mobile electronic devices such as PC tablets (including iPads), e-readers, smartphones, and video displays has created a need for stands to display such devices when in use. Unfortunately, conventional display stand designs often lack stability, adjustability, and/or portability. What is therefore needed are novel display stand systems that are stable, adjustable, and portable.

### SUMMARY OF THE INVENTION

In view of the foregoing, this invention provides designs for display stands that are stable, adjustable, and portable.

In one aspect, the present arrangement provides a display stand. The display includes a housing and a supporting frame retractable from the housing; and wherein when the supporting frame is retracted from the housing, and in an operational state of the display stand, the supporting frame contacts the housing and is immobilized with respect to the housing. In preferred embodiments of the present arrangements, the display stand further includes a retractable sub-assembly that includes the supporting frame, wherein the retractable sub-assembly is retractable from the housing.

In preferred embodiments of the present arrangement, the display stand includes one or more rails retractable from the housing, wherein the one or more rails is coupled on a first end to the housing and on a second end to the retractable sub-assembly. Preferably, the display stand includes a base that is disposed at a bottom part of the retractable sub-assembly and is coupled to the rails, preferably rotatably engaged using a pin convection. In alternate embodiments of the present invention, however, the supporting frame is rotatably engaged with the base of the retractable sub-assembly, preferably using a pin connection.

The display stand also preferably includes a bottom support, which is part of the retractable sub-assembly and is coupled to the supporting frame to stabilize a device positioned on the retractable sub-assembly, preferably a PC tablet, an e-reader, a smartphone, or a video display. Preferably, the bottom support is rotatably engaged with the supporting frame of the retractable sub-assembly, preferably using a pin connection, and in an operational state of the bottom support, the bottom support is positioned above the base. In alternate embodiments of the present arrangement, however, the bottom support is rotatably engaged with the base using a pin connection.

In accordance with one preferred embodiment of the present arrangements, the display stand further includes one or more grooves disposed inside the housing and each of the one or more grooves is designed to secure the one or more rails; and one or more rail blockers disposed inside the housing and designed to prevent discoupling of the one or more rails from the one or more grooves.

In accordance with another embodiment of the present arrangements, the display stand also includes one or more horizontal ridges, each of the horizontal ridges being substantially parallel to each other and displaced on a back side of the supporting frame and designed to engage with the housing in an operational state of the display stand such that the supporting frame is immobilized with respect to the housing. In preferred embodiments of the present arrangements, the housing includes a stopper disposed on a top surface of the housing and designed to engage with each of the one or more ridges of the supporting frame to immobilize the supporting frame with respect to the housing. Preferably, in an operational state of the display stand, the supporting frame is disposed at an angle relative to the one or more rails. More preferably, the housing is capable of engaging with different ones of the one or more ridges, and the supporting frame is disposed at a different angle relative to the one or more rails depending on the selected one of the one or more ridges. More preferably, the supporting frame engages with a ridge that is disposed proximate to the base.

In another aspect, the present arrangement provides a display stand. The display stand includes a supporting frame and a stabilizing component, and wherein the supporting frame, in an operational state, is designed to contact the stabilizing component at different locations along the supporting frame and is immobilized with respect to the stabilizing component. Preferably, the display stand includes a base that is disposed at a bottom end of the supporting frame. More preferably, the display stand includes a bottom support that is coupled to the supporting frame to support at a bottom end a device positioned against the supporting frame.

### BRIEF DESCRIPTION OF THE DRAWINGS

FIG. 1 is a perspective view of a display stand, according to one preferred embodiment of the present arrangements, in a closed configuration.

FIG. 2A is a perspective view of a display stand, according to one preferred embodiment of the present arrangements, in an open and transitional configuration.

FIG. 2B is a perspective view of a display stand, according to one preferred embodiment of the present arrangements, in an open and transitional configuration, showing an internal housing of the display stand.

FIG. 3 is a perspective view of a display stand, according to one preferred embodiment of the present arrangements, in an operational configuration.

FIG. 4 is a side view of a display stand, according to one preferred embodiment of the present arrangements, in an operational configuration.

FIG. 5 is a side view of a display stand, according to one alternate embodiment of the present arrangements, in use in an operational configuration.

FIG. 6 is a side view of a detached retractable sub-assembly, according to one preferred embodiment of the present arrangements, used in a display stand.

FIG. 7 is an exploded, back perspective view of a detached retractable sub-assembly, according to one preferred embodiment of the present arrangements, used in a display stand.

FIG. 8 is a side view of a detached retractable sub-assembly, according to one preferred embodiment of the present arrangements, used in a display stand.

FIG. 9 is an exploded, back perspective view of a detached retractable sub-assembly, according to one preferred embodiment of the present arrangements, used in a display stand.

### DETAILED DESCRIPTION OF THE PREFERRED EMBODIMENTS

In the following description, numerous specific details are set forth in order to provide a thorough understanding of the present invention. It will be apparent, however, to one skilled in the art that the present invention is practiced without limitation to some or all of these specific details.

FIG. 1 shows a display stand 100, according to one preferred embodiment of the present arrangements, in a closed configuration. Display stand 100 includes a base 104, which is attached to retractable components inside a housing 102. As explained in further detail below, base 104 and the attached retractable components are pulled outside of housing 102 to transition from a closed to an open configuration. In the closed configuration of FIG. 1, however, display stand 100 provides the advantage of portability when not in use. In other words, display stand 100 may be transported from one location to another in a compact state when in a closed configuration. Further, in use in an operational configuration, display stand 100 is used to display a screen of an electronic component, for example. In preferred embodiments of the present arrangements, display stand 100 is used to display the screen of one member of a group comprising a PC tablet (including an iPad), an e-reader (e.g., an Amazon Kindle), a smartphone, and a video monitor. In alternate embodiments of the present arrangements, however, display stand 100 is used to support any structure for the purpose of display (e.g., a photograph, painting, drawing, or the like).

Housing 102 and base 104 are comprised of any rigid material capable of supporting the weight of a device for display when device 100 is in use, and light enough to facilitate portability when device 100 is in a closed configuration (as shown in FIG. 1). Housing 102 and base 104 are preferably comprised of one or more members selected from a group comprising a plastic, a metal, an alloy, and carbon fiber. In certain embodiments of the present arrangements, housing 102 and base 104 are both comprised of the same materials, though preferably, housing 102 is comprised of a metal (e.g., aluminum), and base 104 is comprised of plastic and steel. As shown in the embodiment of FIG. 1, device 100 also includes ridges, which are designed to facilitate carrying of device 100, as well as retraction of base 104 from housing 102, by including a ridged surface that facilitates gripping.

FIG. 2A shows a perspective view of a display stand 200, according to one preferred embodiment of the present arrangements, in a transitional configuration (i.e. transitional between a closed configuration and an operational configuration). Housing 202 and base 204 of display stand 200 are similar to their counterparts housing 102 and base 104 in FIG. 1. Display stand 200 also shows a retractable sub-assembly 206 attached to and including base 204. Retractable sub-assembly 206 also includes a bottom support 208 and a supporting frame 210 coupled to base 204. Retractable sub-assembly 206 is also attached on each side to a rail 212a and a rail 212b. Rails 212a and 212b are engaged to an inside portion of housing 202. As the arrow labeled “a” shows, when display stand 200 is transitioning between a closed and open configuration, retractable sub-assembly 206 retracts out of housing 202. Preferably, retractable sub-assembly 206 retracts out of housing 202 along a rail 212a and a rail 212b, though alternate embodiments of the present arrangements contemplate the use of any number of rails.

In the transitional configuration of FIG. 2A, in order to fit components of retractable sub-assembly 206 inside housing 202 while display stand 200 is in a closed configuration, one side of bottom support 208 rests on or near a front surface of supporting frame 210. In a similar manner, one end of supporting frame 210 rests on or near a top surface of rails 212a and 212b.

As explained further below, in order to place inventive display stands in an operational configuration, bottom support 208 is designed to rotate away from a front surface of supporting frame 210, and supporting frame 210 is designed to rotate away from a top surface of rails 212a and 212b. But in a closed and in a transitional configuration, rotation of bottom support 208 towards supporting frame 210, and rotation of supporting frame 210 towards rails 212a and 212b, provides clearance for components of retractable sub-assembly 206 to be moved into and out of housing 202.

Bottom support 208, supporting frame 210, and rails 212a and 212b are each comprised of any rigid material sufficient to facilitate support of a device for display and light enough to facilitate portability of device 200. Preferably, supporting frame 210 and rails 212a and 212b are comprised of steel. In preferred embodiments of the present arrangements, supporting frame 210 and rails 212a and 212b are comprised of the same material as base 204, though in alternate embodiments of the present arrangements, these component parts are comprised of different materials.

FIG. 2B shows a perspective view of a display stand 200′, according to one preferred embodiment of the present arrangements, in a transitional configuration (i.e. transitional between a closed configuration and an operational configuration), and shows certain internal components a housing 202′. Housing 202′, base 204′, retractable sub-assembly 206′, bottom support 208′, supporting frame 210′, rail 212a′, and rail 212b′, are all substantially similar to their counterparts in FIG. 2A. FIG. 2B also shows inside housing 202′ a groove 232a, a groove 232b, a rail connector 222, and a blocker 234.

Grooves 232a and 232b are each designed to align with and secure corresponding rails 212a′ and 212b′, facilitating a smooth retraction retractable sub-assembly 206′ out of housing 202. In preferred embodiments of the present arrangements, rail connector 222 connects rails 212a′ and 212b′, forming a single, discrete structure. In alternate embodiments of the present arrangements, rail connector 222 is a separate structure attached to each of rails 212a′ and 212b′. In certain other embodiments of the present arrangements, however, a rail connector 222 is not used. Preferably, rail connector 222 is comprised of the same material as rails 212a′ and 212b. Grooves 232a and 232b are preferably comprised of steel.

As shown in FIG. 2B, blocker 234 is preferably disposed at a front end of the lower internal surface of housing 202′. During retraction of retractable sub-assembly 206′ out of housing 202′, blocker 234 prevents disengagement of rails 212a′ and 212b′ from grooves 232a and 232b, respectively, by blocking rail connector 222 from retracting outside of housing 202. In those embodiments that do not utilize a rail connector 222, other mechanisms known to those of skill in the art are used to prevent disengagement of rails from the internal housing of the inventive display stand.

FIG. 3 shows a perspective view of a display stand 300, according to one preferred embodiment of the present arrangements, in an operational configuration. Housing 302, base 304, retractable sub-assembly 306, bottom support 308, supporting frame 310, and track 312 are substantially similar to their counterparts in FIGS. 1 and 2.

As shown in FIG. 3, arrow “a” shows track 312 partially retracted into housing 302 in order to place the inventive display stand in an operational configuration, i.e., with supporting frame 310 abutting a leading edge of housing 302. Though not shown in FIG. 3, in order to place device 300 in an operational configuration, retractable sub-assembly 306 must be retracted outside of housing 302 at a distance sufficient to allow a top end of supporting frame 310 clearance past a leading edge of housing 302 during rotation of supporting frame 310. To this end, arrow “b” shows the direction of rotation of supporting frame 310 away from track 312. To facilitate this rotation, supporting frame 310 is preferably coupled to base 304. In such embodiments, base 304 is rotatably engaged to rail 212 using a pin connection (described below with reference to FIGS. 6 and 7). In alternate embodiments of the present arrangements, supporting frame 310 is rotatably engaged to base 304 with a pin connection. In either of these embodiments, supporting frame 310 is designed to rotate away from rail 312 with enough room to clear a leading edge of housing 302, and subsequently, is designed to rotate toward rail 312, after partial retraction back into housing 302 (as shown by arrow “a”). In this manner, supporting frame 310 is stabilized by abutting a leading edge of housing 302.

Further, in transitioning from a closed to an operational configuration, bottom support 308 is preferably rotated away from support frame 310 at an angle sufficient for bottom support 308 to support a display device. To this end, arrow “c” shows a bottom end of bottom support 308 rotated to a position that is about a 90 degree angle relative to support frame 310 and resting on or near a top surface of base 304. As explained below with reference to FIGS. 8 and 9, to accomplish this, bottom support 308 is preferably rotatably coupled to base 304 with a pin connection that allows for rotation of bottom support 308 between base 304 and support frame 310. In alternate embodiments of the present arrangements, however, bottom support 308 is rotatably coupled to supporting frame 310.

FIG. 4 shows a side view of a display stand 400, according to one preferred embodiment of the present arrangements, in an operational configuration. Housing 402, base 404, bottom support 408, supporting frame 410, and track 412 are substantially similar to their counterparts in FIGS. 1, 2, and 3.

Display stand 400 also includes ridges 414, which are used to position supporting frame 410 at various angles for viewing a device for display. As shown in FIG. 4, a leading edge of housing 402 preferably abuts a back side of supporting frame 410 adjacent to at least one ridge 414 to stabilize retractable sub-assembly 406 relative to housing 402. In this manner, a load is placed on and supported by housing 402.

By configuring display stand 400 with one or more ridges 414 along a back end of support frame 410, the present arrangements provide the advantage of adjustability of retractable sub-assembly 406, which provides various viewing angles of a device for display. By way of example, placing the leading edge of housing 402 against a ridge 414 closer to a top end of support frame 410 will decrease the angle of retractable sub-assembly 416 relative to track 412. The present teachings recognize that as this angle progressively decreases, retractable sub-assembly 416 becomes increasingly more stable. Alternate embodiments of the present invention do not require the use of ridges, and instead use other means for stabilizing retractable sub-assembly 406 relative to housing 402, including but not limited to friction.

FIG. 5 shows a display stand 500, according to one alternate embodiment of the present arrangements, in use in an operational configuration. Housing 502, base 504, bottom support 508, support frame 510, rail 512, and ridges 514 are substantially similar to their counterparts in FIGS. 1-4. FIG. 5, however, includes a stopper 518 (not shown in FIGS. 1-4) that is designed to engage with a ridge 514, therefore stabilizing a device 516 for viewing. Preferably, device 516 is one member chosen from a group comprising a PC tablet, an e-reader, a smartphone, and a video monitor.

In preferred embodiments of the present arrangements, stopper 518 is optionally disposed on a top surface of a leading edge of housing 502. In this manner, when display stand 500 is in an operational configuration, at least one of ridges 514 engages with stopper 518 to stabilize display stand 500. Preferably, stopper 518 is configured with a groove designed to receive a ridge 514. In such manner, stopper 518 facilitates stabilization display stand 500 in an operational configuration. Preferably, stopper 518 is comprised of rubber, though alternate embodiments of the present arrangements contemplate use of any material sufficient to add stability to display stand 500 when in an operational state.

As shown in FIG. 5, bottom support 508 is preferably configured at one end in an “L” configuration. Thus, when display stand 500 is in use in an operational configuration, a bottom end of device 516 is stabilized both horizontally (i.e., by the upward end of bottom support 508) and vertically (i.e., by the lower edge of bottom support 508). In such manner, device 516 is further stabilized when it is lodged in the outer corner portion of bottom support 508.

FIG. 6 shows a detached retractable sub-assembly 606, according to one preferred embodiment of the present arrangements. Base 604, supporting frame 610, rail 612, and ridges 614 are substantially similar to their counterparts in FIGS. 1-5. Further, FIG. 6 shows, disposed at a first end of rail 612, a pin-receiving portion 628 having an aperture designed therethrough (shown by arrow “a”). Likewise, base 604 includes an aperture designed therethrough (shown by arrow “b”). The aperture of pin-receiving portion 628 (“a”) is configured to align with the aperture of base 604 (“b”). In an assembled state of the inventive design stand, a pin secures base 604 with rail 612 and facilitates rotation of base 604, which is attached to support frame 610, in order to transition the inventive design stand between a closed and an operational configuration.

While the embodiment of FIG. 6 shows a retractable sub-assembly 606 detached from a housing (e.g., housing 102 of FIG. 1), in alternate embodiments of the present invention, the arrangement of FIG. 6 is used as a display stand that does not require a housing. In such embodiments, alternate means are used to stabilize supporting frame 610 to secure a device for viewing. By way of example, in alternate embodiments of the present arrangement, rail 612 is designed at one end with, for example, an “L”-shaped or “U”-shaped configuration that acts as a stabilizing component. In such manner, the stabilizing component contacts supporting frame 610, stabilizing supporting frame 610 relative to rail 612. In preferred embodiments of the present arrangement, the stabilizing component is configured to contact supporting frame 610 at different locations along supporting frame 610, providing the advantage of adjustability of viewing angle when the inventive display stand is in use. Further, by way of example, in other alternate embodiments of the present arrangement, a pin connection between base 604 and rail 612 is configured with a locking mechanism capable of securing supporting frame 610 relative to rail 612 at a variety of viewing angles when the inventive display stand is in use.

FIG. 7 shows an exploded, perspective view of a back side of a retractable sub-assembly 706, according to one preferred embodiment of the present arrangements. Base 704, supporting frame 710, rails 712a and 712b, rail connector 722, and pin connectors 728a and 728b, are substantially similar to their counterparts in FIGS. 1-6. FIG. 7 also shows a pin 724a and a pin 724b, designed to secure rails 712a and 712b to base 704. Each of pins 724a and 724b is any device capable of securing rails 712a and 712b to base 704 and allowing rotation of base 704 relative to rails 712a and 712b. Preferably, each of pins 724a and 724b is one member chosen from a group comprising a pin, a nail, and a screw.

In an assembled state, apertures in pin connectors 728a and 728b (shown by arrow “a” for pin connector 724b) align, respectively, with apertures configured in the outer side of ridges configured in base 704 (shown in one instance by arrow “b”), and are secured by pins 724a and 724b, respectively. In alternate embodiments of the present arrangements, however, apertures are configured in the inner side of ridges configured in base 704. The pin connections facilitate rotation of base 704 and the attached supporting frame 710 towards rails 712a and 712b. In such manner, retractable sub-assembly 706 is placed in a configuration that fits in a housing (e.g., housing 102 of FIG. 1). Likewise, the same pin connection is used to facilitate rotation of supporting frame 710 away from rails 712a and 712b, facilitating transition of the inventive display stand into an operational configuration.

While the embodiment of FIG. 7 shows rails 712a and 712b rotatably engaged with base 704, in alternate embodiments of the present arrangements, supporting frame 710 is rotatably engaged with base 704. In such embodiments, supporting frame is 710 is rotated relative to rails 712a and 712b to facilitate transition of the inventive display stand between an open and a closed configuration.

FIG. 8 shows a detached retractable sub-assembly 806, according to one preferred embodiment of the present arrangements. Base 804, bottom support 808, supporting frame 810, and ridges 814 are substantially similar to their counterparts in FIGS. 1-7. FIG. 8 also shows, attached to a bottom end of supporting frame 810, a pin-receiving portion 830 with an aperture defined therethrough (shown at arrow “a”), and attached to one end of bottom support 808, a pin-receiving portion 832 with an aperture defined therethrough (shows at arrow “b”). In an assembled state, pin-receiving portion 830 and pin-receiving portion 832 align and are preferably secured together by one member selected from a group comprising a pin, a screw, and a nail, permitting rotation of bottom support 808 relative to supporting frame 810.

FIG. 9 shows a back, perspective, exploded view of a retractable sub-assembly 906, according to one preferred embodiment of the present arrangements. Base 904, bottom support 908, supporting frame 910, pin-receiving portions 930a and 930b, and pin-receiving portions 932a and 932b are substantially similar to their counterparts in FIGS. 1-8. FIG. 9 also shows a pin 934a and pin 934b. Each of pins 934a and 934b is any device capable of securing bottom support 908 to supporting gram 910 and allowing rotation of bottom support 908 relative to supporting frame 910. Preferably, each of pins 934a and 934b is one member chosen from a group comprising a pin, a nail, and a screw.

In a closed configuration of the inventive display stand, bottom support 908 is rotated towards supporting frame 910, facilitating retraction of retractable sub-assembly 906 into a housing (e.g., housing 102 of FIG. 1). Likewise, to transition retractable sub-assembly 906 into an operational configuration, bottom support 906 is rotated away from supporting frame 910, until it abuts base 904. In certain alternate embodiments of the present arrangements, however, bottom support 908 is rotatably engaged to base 904. In such embodiments, bottom support 908 is capable of rotation in a manner that facilitates transition of the inventive display stand between a closed and an operation configuration.

Although illustrative embodiments of this invention have been shown and described, other modifications, changes, and substitutions are intended. Accordingly, it is appropriate that the disclosure be construed broadly.

What is claimed is:

1. A display stand, comprising:
a housing;
a supporting frame retractable from said housing; and
wherein when said supporting frame is retracted from said housing, and in an operational state of said display stand, said supporting frame contacts said housing and is immobilized with respect to said housing.

2. The display stand of claim 1, further comprising a retractable sub-assembly that includes said supporting frame, wherein said retractable sub-assembly is retractable from said housing.

3. The display stand of claim 2, further comprising one or more rails retractable from said housing, wherein said one or more rails is coupled on a first end to said housing and on a second end to said retractable sub-assembly.

4. The display stand of claim 3, further comprising a base that is disposed at a bottom part of said retractable sub-assembly and is coupled to said rails.

5. The display stand of claim 4, wherein said base is rotatably engaged with said rails using a pin connection.

6. The display stand of claim 3, further comprising
one or more grooves disposed inside said housing and each of said one or more grooves designed to secure said one or more rails; and
one or more rail blockers disposed inside said housing and designed to prevent discoupling of said one or more rails from said one or more grooves.

7. The display stand of claim 4, further comprising a bottom support, which is part of said retractable sub-assembly and is coupled to said supporting frame to stabilize a device positioned on said retractable sub-assembly.

8. The display stand of claim 7, wherein said device is at least one member chosen from a group comprising a PC tablet, an e-reader, a smartphone, and a video display.

9. The display stand of claim 8, wherein said bottom support is rotatably engaged with said supporting frame of said retractable sub-assembly and in an operational state of said bottom support, said bottom supports is positioned above said base.

10. The display stand of claim 9, wherein said bottom support is rotatably engaged with said supporting frame of said retractable sub-assembly using a pin connection.

11. The display stand of claim 4, further comprising a bottom support that is rotatably engaged with said base using a pin connection.

12. The display stand of claim 4, wherein said supporting frame is rotatably engaged with said base of said retractable sub-assembly using a pin connection.

13. The display stand of claim 1, further comprising one or more horizontal ridges, each of said horizontal ridges being substantially parallel to each other and displaced on a back side of said supporting frame and designed to engage with said housing in an operational state of said display stand such that said supporting frame is immobilized with respect to said housing.

14. The display stand of claim 6, wherein said housing includes a stopper disposed on a top surface of said housing and designed to engage with each of said one or more ridges of said supporting frame to immobilize said supporting frame with respect to said housing.

15. The display stand of claim 14, wherein in an operational state of said display stand, said supporting frame is disposed at an angle relative to said one or more rails.

16. The display stand of claim 14, wherein said housing is capable of engaging with different ones of said one or more ridges and said supporting frame is disposed at a different angle relative to said one or more rails depending on the selected one of said one or more ridges.

17. The display stand of claim 1, wherein when said supporting frame engages with a ridge that is disposed proximate to said base.

18. A display stand, comprising:
a supporting frame;
a stabilizing component; and
wherein said supporting frame, in an operational state, is designed to contact said stabilizing component at different locations along said supporting frame and is immobilized with respect to said stabilizing component.

19. The display stand of claim 18, further comprising a base that is disposed at a bottom end of said supporting frame.

20. The display stand of claim 19, further comprising a bottom support that is coupled to said supporting frame to support at a bottom end a device positioned against said supporting frame.
